(19) United States
(12) Patent Application Publication
(10) Pub. No.: US 2026/0146210 A1
(43) Pub. Date: May 28, 2026

(54) METHOD OF FEEDING A SUBSTANCE WITH PROPERTIES OF REDUCING HYDRAULIC RESISTANCE INTO A FLOW OF HYDROCARBONS AND METHOD OF TRANSPORTING HYDROCARBONS

(71) Applicant: IRIS TECH, INC., Houston, TX (US)

(72) Inventors: Roman Nikolaevich KOSTROMIN, Houston, TX (US); Vladimir Dmitrievich MOROZOV, Houston, TX (US); Ivan Valeryevich KUZNETSOV, Houston, TX (US); Aleksandr Aleksandrovich NIKITIN, Houston, TX (US); Igor Aleksandrovich MALYKHIN, Houston, TX (US)

(21) Appl. No.: 18/958,014

(22) Filed: Nov. 25, 2024

(51) Int. Cl. C10L 1/195

(52) U.S. Cl. CPC C10L 1/195; C10L 2230/14; C10L 2290/28

(57) ABSTRACT

The disclosed method of feeding a substance with properties of reducing hydraulic resistance into a flow of hydrocarbons, includes the following steps: supplying the substance in the form of an amorphous polymeric mass with at least one dissolution modifying agent to an inlet of a dosing device; adding a mixture produced at an outlet of the dosing device to a predetermined volume of hydrocarbons using a grinder to produce gel, suspension, or mixture thereof uniformly distributed over the volume of hydrocarbons; supplying the produced gel, suspension, or mixture thereof to the hydrocarbon stream in a pipeline using a pump; and the dosing of the dissolution modifying agent into the amorphous polymeric mass depends on at least one of the factors, including hydrocarbon parameters and length of the pipeline.

### TECHNICAL FIELD

This invention relates to fluid conveying facilitation, more specifically, to a method for feeding substances capable of hydraulic resistance reduction into a pipeline.

### BACKGROUND OF THE INVENTION

Substances, in particular polymers with hydraulic resistance reduction properties known as drag reducing agents (DRA), are used when pumping hydrocarbons through pipelines to reduce transportation costs. Pumps are used for liquid DRA injections, while more complex injection systems are used for fine-dispersed dry DRA injections, including dosing screws and predissolving chambers. The use of DRA in the form of coarse particles (such as crumbs, granules, etc.) requires preliminary size reduction of DRA, as the ingress of coarse particles into a hydrocarbon stream has a very slight effect on the hydraulic resistance reduction.

This invention provides for the feeding of an amorphous polymeric mass into the hydrocarbon stream together with a dissolution modifying agent.

A known invention for the hydraulic resistance reduction (U.S. Pat. No. 11,608,466B2, published on 2023 Mar. 21) introduces a solid resistance reducing additive into a liquid hydrocarbon stream, wherein the solid resistance reducing additive comprises a polymeric particle derived from at least one polar monomer and a liquid having a mass content of less than 50 wt %.

However, this invention does not address the presence or dosing of dissolution modifying agents depending on characteristics of hydrocarbons or pipelines through which the hydrocarbons are transported.

A previously patented invention titled Bi- or Multi-Modal Particle Size Distribution to Improve Drag Reduction Polymer Dissolution (U.S. Pat. No. 7,939,584B2, published on 2011 May 10) discloses that drag reduction of hydrocarbon fluids flowing through pipelines of various lengths is improved by polyolefin DRA dispersions or dispersions using bi- or multi-modal particle size distributions. DRAs having larger particle sizes dissolve more slowly than DRAs having smaller particle sizes. By using at least bi-modal particle size distributions DRA can be distributed more uniformly over the length of the pipeline where smaller sized particles dissolve sooner in the pipeline and larger sized particles dissolve later or further along the pipeline.

However, this invention does not address the presence or dosing of dissolution modifying agents depending on characteristics of hydrocarbons or pipelines through which the hydrocarbons are transported.

### BRIEF STATEMENT OF THE INVENTION

In one aspect of the invention disclosed is a method of feeding a substance with properties of reducing hydraulic resistance into a flow of hydrocarbons, comprising the steps of:
supplying said substance in the form of an amorphous polymeric mass with a dissolution modifying agent to an inlet of a dosing device;
adding a mixture produced at an outlet of the dosing device to a predetermined volume of hydrocarbons by means of a grinder to produce gel, suspension, or mixture thereof uniformly distributed over the volume of hydrocarbons;
supplying the produced gel, suspension, or mixture thereof to the hydrocarbon stream in a pipeline using a pump;

Whereas the dosing of the dissolution modifying agent into the amorphous polymeric mass depends on at least one of the factors comprising hydrocarbon parameters and length of the pipeline.

In additional aspects, it is disclosed that the dissolution modifying agents are additives that reduce or increase the dissolution rate of the amorphous polymeric mass in the hydrocarbon stream; the dissolution modifying agent is selected from the group consisting of silicone oil, rapeseed oil, canola oil, soybean oil, sunflower oil, cotton seed oil, palm oil, vegetable oil, methyl alcohol, propylene glycol, ethylene glycol, ethyl alcohol, 2-ethylhexanol, rapeseed oil fatty acids, canola oil fatty acids, soybean oil fatty acids, sunflower oil fatty acids, cotton seed oil fatty acids, palm oil fatty acids, vegetable oil fatty acids, octanol, decanol, dodecanol, texanol and ethylene glycol methyl ether; at least two dissolution modifying agents are used in such a manner that increases the uniformity of the action of the amorphous polymeric mass along the length of the pipeline; and the dosing device is one of the following: screw feeder, metering pump, conveyor belt, or sectional feeder; and the grinder is one of the following: disk mill, colloid mill, ball mill, attrition mill, cam-type grinder, auger mixer, roller mixer, disperser, or mixer; the parameters of the hydrocarbon represent at least the temperature of the hydrocarbon and the hydrocarbon composition.

In another aspect disclosed is a method of transporting hydrocarbons, comprising the steps of:
supplying said substance with hydraulic resistance reduction properties in the form of an amorphous polymeric mass with a dissolution modifying agent to an inlet of a dosing device;
adding a mixture produced at an outlet of the dosing device to a predetermined volume of hydrocarbons by means of a grinder to produce gel, suspension, or mixture thereof uniformly distributed over the volume of hydrocarbons;
supplying the produced gel, suspension, or mixture thereof to the hydrocarbon stream in a pipeline using a pump;
transporting the hydrocarbon stream through the pipeline using a second pump;
   whereas the dosing of the dissolution modifying agent into the amorphous polymeric mass depends on at least one of the factors comprising hydrocarbon parameters and length of the pipeline.

The main problem solved by the claimed invention is to control the properties of the substance with hydraulic resistance reduction properties, in particular acrylate-based or polyalphaolefin-based polymers, functional additives, surface active substances, adhesion reducing powder, dissolution modifying agents, wetting agents, or a combination thereof, to provide a more uniform hydraulic resistance reduction performance in the pipeline.

The invention consists of adding the dissolution modifying agent to a dry substance with hydraulic resistance reduction properties (SWHRRP); these are fed together to the inlet of the dosing device, which mixes them in the process of dosing. The dosing device directs the mixture into the predetermined volume of hydrocarbons, which is then directed to the grinder, at the outlet of which gel, suspension, or mixture thereof is formed. This gel, suspension, or mixture is further directed into the hydrocarbon stream to reduce hydraulic resistance during its transportation.

The technical result achieved by this invention is an increase of the uniformity of the substances action with hydraulic resistance reduction properties within the pipeline.

### BRIEF DESCRIPTION OF DRAWINGS

FIG. 1 shows a block diagram of the steps of the claimed method.

FIG. 2 shows an installation diagram for the realization of the claimed method.

### DETAILED DESCRIPTION

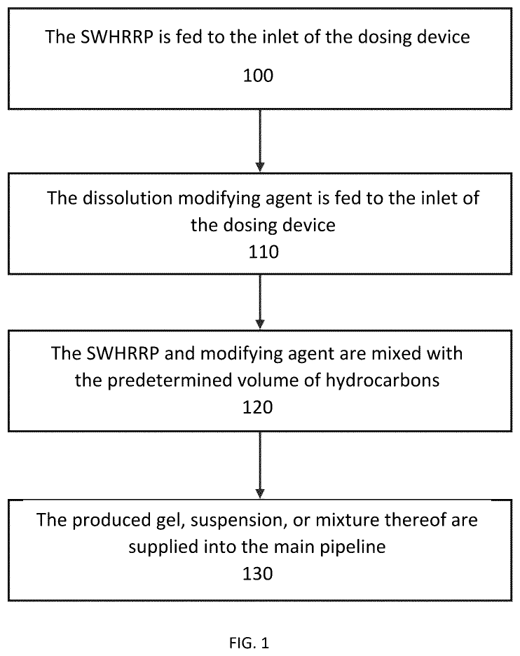

In one embodiment, the method for feeding the SWHRRP into the hydrocarbon stream illustrated in FIG. 1, wherein:
100—feeding the SWHRRP into the inlet of the dosing device,
110—feeding the dissolution modifying agent into the inlet of the dosing device,
120—mixing the SWHRRP with the dissolution modifying agent, including the predetermined volume of hydrocarbons,
130—directing the produced gel, suspension, or mixture thereof to the main pipeline.

The substance with hydraulic resistance reduction properties for the hydrocarbon stream in the pipeline may be at least one of the following groups: acrylate-based or polyalphaolefin-based polymers, functional additives, surface active substances, adhesion reducing powder, wetting agents, or a combination thereof.

Substances with hydraulic resistance reduction properties may be fed into the pipeline with the hydrocarbon stream (oil, oil-water mixture, oil-gas-condensate mixture, petroleum products, etc.) in the form of a suspension, fine powder, or a mixture thereof.

According to the invention, the preferred embodiment initially comprises the amorphous polymeric mass in the form of a continuous homogeneous substance, which is supplied (steps 100, 110) to the inlet of the dosing device together with the dissolution modifying agent, resulting in a homogeneous amorphous polymeric mass at the outlet of the dosing device. For example, such a mass is formed at the outlet of a screw conveying the polymeric powder or particles together with the dissolution modifying agent from a storage tank to a mixing tank or to a branch of the main hydrocarbon stream, wherein the dissolution modifying agent is supplied continuously or cyclically to the screw inlet by a feeder. Alternatively, a metering pump may be used instead of the screw, which is designed to mix the SWHRRP and the dissolution modifying agent until the formation of homogeneous amorphous polymeric mass.

The dissolution modifying agent represents one of the following groups: ethylene glycol, propylene glycol, ethylene glycol methyl ether, methyl alcohol, ethyl alcohol, octanol, 2-ethylhexanol, decanol, dodecanol, texanol, rapeseed oil, canola oil, soybean oil, sunflower oil, cotton seed oil, palm oil, vegetable oil, rapeseed oil fatty acids, canola oil fatty acids, soybean oil fatty acids, sunflower oil fatty acids, cotton seed oil fatty acids, palm oil fatty acids, vegetable oil fatty acids, silicone oil, or a combination thereof. The dissolution modifying agent is supplied to the inlet of the screw, wetting the powder or particles, and, due to the pressure of the screw, this mixture becomes homogenized and paste-like. The screw should preferably be conical to create the necessary pressure and to increase the dosing accuracy.

The produced mixture is directed to a mixing tank or branch of the main pipeline carrying the hydrocarbon stream, where it is mixed (step 120) with the predetermined volume of hydrocarbons from the main pipeline using the grinder. The grinder may comprise one of the following groups: disk mill, colloid mill, ball mill, attrition mill, cam-type grinder, auger mixer, roller mixer, disperser, or mixer.

Gel, suspension, or mixture thereof is formed at the outlet of the grinder. A specific form depends on the type of substance with hydraulic resistance reduction properties, the amount and type of the dissolution modifying agent, the hydrocarbon composition, the mass ratio of said components, and the temperature of the gel, suspension, or mixture thereof. The only relevant aspect is that the initial amorphous polymeric mass is mixed with the dissolution modifying agent to form a paste-like substance that is size-reduced and uniformly mixed with the hydrocarbon to start exhibiting its hydraulic resistance reduction properties when it enters the main stream. Size reduction is necessary because large particles will take a very long time to dissolve and will not reduce hydraulic resistance to the same extent as smaller particles of the same mass.

The gel, suspension, or mixture thereof produced at the outlet of the grinder is pumped by any suitable pump into the main pipeline with hydrocarbon (step 130), where it begins to exhibit properties of hydraulic resistance reduction. Moreover, the rate of exhibiting of these properties depends on the type and amount of the dissolution modifying agent, which can both decrease or increase the dissolution time.

The type and amount of the dissolution modifying agent are determined based on the temperature of the hydrocarbons. For example, at low hydrocarbon temperatures, more dissolution modifying agent is required to accelerate the dissolution of the SWHRRP and provide a more rapid reduction in hydraulic resistance, whereas a smaller amount of the dissolution modifying agent is required at high temperatures.

If the modifying agent is aimed at slowing down the dissolution of the SWHRRP, then a smaller amount of the modifying agent is required at lower hydrocarbon temperatures and vice versa.

The results of the study of the effect of some dissolution modifying agents on performance of the SWHRRP are shown in Table 1 below.

The data for Table 1 were obtained on a Flow Loop type hydraulic test rig, which reproduces conditions of stream flow in a pipeline in turbulent mode using a pumpless method.

The principle of the method is to measure differential pressure and flow rate in a test section (TS) of a given length and diameter for two cases:
1. Test without the SWHRRP (blank test);
2. Test with the SWHRRP.

The test procedure is as follows:
1. Circulation of the hydrocarbon at specified speed and temperature in steady-state modes is performed, with readings recorded from the measurement system. The main indicators are the flow rate and pressure drop in the TS.
2. The injection of the SWHRRP or the SWHRRP with dissolution modifying agent into a feed drum is performed.
3. By means of gas supply, the pressure in the drum is pressurized to a predetermined level (determined experimentally by a series of preliminary tests without the SWHRRP). After this, a shut-off valve is opened, and fluid is pumped into the TS. As a result of the test, readings of the drop in differential pressure and change in flow rate are recorded;
4. The effect of the application of the SWHRRP obtained during the test is evaluated by calculating the reduction in pressure drop.

The effect of feeding the SWHRRP (including the modifying agent) into the stream is expressed as follows:
1. Decrease in differential pressure (dP);
2. Increase in flow rate.

These effects are determined by the reduction of the hydraulic resistance coefficient. The efficiency of the DRA is assessed by comparing numerical values of the hydraulic resistance coefficients before and after the feeding of the DRA.

$${DR}_{DRA} = \frac{{λ}_{before feeding} - {λ}_{after feeding}}{{λ}_{before feeding}} * 100 \qquad ( 1 )$$

The Darcy-Weisbach equation is used to calculate the pressure drop (ΔP):

$$Δ P = λ \frac{L}{d} \frac{{ϑ}^{2}}{2} ρ \qquad ( 2 )$$

$$ϑ = \frac{Q}{S} = \frac{Q}{π {r}^{2}} = \frac{4 Q}{π {D}^{2}} \qquad ( 3 )$$

$$FROM ( 2 ) λ = \frac{Δ P 2 D}{L {ϑ}^{2} ρ} \qquad ( 4 )$$

Substituting the linear velocity from (3) into (4) gives the following (5):

$$λ = \frac{{π}^{2} Δ {PD}^{5}}{8 {LQ}^{2} ρ} \qquad ( 5 )$$

Before and after the DRA feeding, the values of pressure drop (ΔP) and volume flow rate (Q) change. After substituting formula (5) and reducing the hydraulic resistance (λ) into formula (1), we obtain the following equation:

$${DR}_{DRA} , \% = ( 1 - \frac{Δ {P}_{2} * {Q}_{1}^{2}}{Δ {P}_{1} * {Q}_{2}^{2}} ) * 100 \%$$

In the experiments according to Table 1, different dissolution modifying agents were applied under the same conditions and their effects on the reduction of hydraulic resistance over time were determined.

TABLE 1
Action of Different Dissolution Modifying Agents

| | Reduction of Hydraulic Resistance, % | | |
|---|---|---|---|
| Modifying Agent | 20 min | 40 min | 80 min |
| Without modifying agent | 10 | 30 | 39 |
| ethylene glycol | 10 | 28 | 38 |
| propylene glycol | 10 | 27 | 39 |
| ethylene glycol methyl ether | 10 | 29 | 40 |
| methyl alcohol | 12 | 30 | 39 |
| ethyl alcohol | 12 | 30 | 39 |
| octanol | 14 | 33 | 40 |
| 2-ethylhexanol | 15 | 37 | 40 |
| rapeseed oil | 15 | 37 | 39 |
| rapeseed oil fatty acids | 12 | 35 | 39 |
| silicone oil, 200 cPs | 10 | 28 | 38 |

A polymer based on acrylic monomer was used as the SWHRRP in Table 1, and one of the presented dissolution modifying agents was added to it in the amount of 1 wt %. The produced mixture was size-reduced and mixed in the mixing tank for 24, 40, and 80 minutes with hydrocarbons and then fed to the TS. The temperature of the mixture was maintained at 20° C. After that, the decrease in hydraulic resistance after the mixture was fed into the TS was measured and compared with the hydraulic resistance prior to the feeding.

As can be seen from Table 1, rapeseed oil and 2-ethylhexanol provide a 50% greater reduction in hydraulic resistance than, for example, silicone oil, 20 minutes after the mixture is fed into the pipeline. After 80 minutes, the effect of these modifying agents stops and almost the same value of hydraulic resistance reduction is observed in all experiments.

The effect of the amount of the dissolution modifying agent on the decrease in hydraulic resistance over time was further investigated (see Table 2).

TABLE 2
Effect of Amount of Dissolution Modifying Agents

| | |
|---|---|
| Modifying Agents | Reduction of Hydraulic Resistance, % |

| Content, wt % | 20 min | 40 min | 80 min |
|---|---|---|---|
| 0 | 10 | 24 | 40 |
| 0.1 | 10 | 25 | 40 |
| 0.2 | 11 | 28 | 41 |
| 0.3 | 11 | 29 | 40 |
| 0.4 | 10 | 28 | 40 |
| 0.5 | 11 | 29 | 39 |
| 0.6 | 12 | 30 | 40 |
| 0.7 | 14 | 33 | 40 |
| 0.8 | 14 | 35 | 39 |
| 0.9 | 15 | 35 | 40 |
| 1 | 15 | 37 | 40 |
| 1.1 | 15 | 36 | 39 |
| 1.2 | 15 | 38 | 40 |
| 1.3 | 15 | 38 | 40 |
| 1.4 | 15 | 38 | 40 |

The polymer based on acrylic monomer, and rapeseed oil as the dissolution modifying agent were used in the experiment according to Table 2. The temperature of the experiment was 20° C. According to the results of the experiments, it was revealed that when the amount of the dissolution modifying agent exceeds approximately 1 wt % of the polymer weight, there is no change in the reduction of hydraulic resistance, which determines the upper limit of its content in the mixture. Meanwhile, the effect of its application is about 80% when the amount of the modifying agent is 0.7 wt %, which defines the lower limit of its application.

The effect of the dissolution modifying agent on the reduction of hydraulic resistance depending on the temperature of the hydrocarbon in the pipeline was also studied (see Table 3). In the studies according to Table 3, the polymer based on acrylic monomer was used, with the mass content of the modifying agent being 1 wt %.

TABLE 3
Temperature Effect on Modifying Agents Performance

| | Efficiency, % | | | | | | | | |
|---|---|---|---|---|---|---|---|---|---|
| | When 20° C. | | | When 30° C. | | | When 40° C. | | |
| | 20 | 40 | 80 | 20 | 40 | 80 | 20 | 40 | 80 |
| Modifying Agent | min | min | min | min | min | min | min | min | min |
| Without modifying | 12 | 27 | 38 | 13 | 35 | 40 | 15 | 38 | 40 |
| agent | | | | | | | | | |
| 2-ethylhexanol | 14 | 33 | 40 | 16 | 35 | 40 | 16 | 38 | 40 |
| rapeseed oil | 15 | 37 | 40 | 16 | 37 | 40 | 16 | 37 | 40 |
| silicone oil, 200 cPs | 10 | 28 | 38 | 14 | 37 | 40 | 16 | 38 | 39 |
| ethylene glycol | 10 | 28 | 38 | 12 | 33 | 40 | 14 | 37 | 38 |

Table 3 shows that as the temperature increases, the effect of the dissolution modifying agent decreases, so that at 40° C., the effect of introducing the dissolution modifying agent is almost nonexistent. Thus, at lower temperatures, less modifying agent is required to achieve the same effect.

The researchers found that ensuring a more uniform action of the SWHRRP throughout the pipeline is achieved by dosing the dissolution modifying agent in such a way that some part of the mixture of the SWHRRP with modifying agent starts to act earlier while another part acts later, or it is achieved by dosing different dissolution modifying agents at different times. This is caused by the properties loss of the SWHRRP along the length of the pipeline.

This means that if the dissolution modifying agent is dosed increasing the rate of action of the SWHRRP, then initially a larger amount of the modifying agent is dosed, and after a given time, a smaller amount is fed. This leads to the fact that the mixture of the SWHRRP and the modifying agent initially fed into the pipeline begins to act earlier, while at the next stage, where the mixture is fed, there will be a longer dissolution time, and the mixture will act at a more distant section of the pipeline from the point of feeding. This provides a more uniform and longer-lasting effect of the SWHRRP.

The dosing mode of the dissolution modifying agent is selected in such a way (dosing intervals, dosing time, amount of modifying agent) to ensure optimal dissolution of the SWHRRP through the pipeline (provided by the dissolution modifying agent). The dosing mode may be continuous or cyclic. Continuous dosing of the dissolution modifying agent may be chosen for cases where there is no need to change the properties of the SWHRRP. For short pipelines (less than 40 km), continuous dosing of a solutizer such as rapeseed oil is possible.

Cyclic dosing of the dissolution modifying agent can be chosen for cases where it is necessary to change the properties of the SWHRRP. For long pipelines (more than 200 km), cyclic dosing of a dissolution retarder, e.g., silicone oil, is possible. In such a case, a part of the SWHRRP without the dissolution retarder will dissolve and be effective up to 100 km, while another part of the SWHRRP with the dissolution retarder will dissolve more slowly and will be effective after 100 km.

For this purpose, the dissolution modifying agent feeder may operate cyclically and provide the dissolution modifying agent to the continuously fed SWHRRP on a time basis, for example, 1 minute apart for 1 minute, 30 seconds apart for 30 seconds, 15 seconds apart for 15 seconds, 10 seconds apart for 10 seconds, and 5 seconds apart for 5 seconds.

If the dissolution modifying agent is dosed in a manner that reduces the rate of action of the SWHRRP, then conversely, a small amount of the dissolution modifying agent should be dosed first, followed by a larger amount.

In one embodiment, the SWHRRP containing the solutizer is initially fed into the pipeline, and the amount of this solutizer is gradually decreased from a maximum value to zero, resulting in a gradual increase in dissolution time and an increase in the distance over which the SWHRRP begins to act. When the amount of the solutizer reaches zero, the feeding of the dissolution retarder begins, and the amount of this retarder is gradually increased from zero to a maximum value. The maximum value is selected from Table 2. After reaching the maximum value, the described cycle starts again.

In one embodiment, dosing means of the SWHRRP comprise the following elements:
200—storage tank for the SWHRRP,
210—dosing device,
220—storage tank for the dissolution modifying agents,
230—mixing tank,
240—branch of the pipeline (250),
250—pipeline,
260—grinder,
270—pump.

The SWHRRP storage tank 200 is coupled to the dosing device 210, allowing for the transfer of the SWHRRP to the mixing tank 230, which may be either a mixing container or a branch line. The dissolution modifying agents storage tank 220 is configured to supply the dissolution modifying agent to the inlet of the dosing device 210 via the feeder 210. The outlet of the dosing device 210 is connected to the inlet of the mixing tank 230, to which the branch 240 of the main pipeline 250 is connected, through which said predetermined volume of hydrocarbon is supplied for mixing with the dissolution modifying agent including the SWHRRP. The specific value of said predetermined volume can be chosen from a wide range, the main criterion is the possibility of producing gel, suspension, or mixture thereof at the outlet of the grinder 260 to which the mixture from the tank 230 is fed.

Dosing of the mixture from the outlet of the grinder 260 is accomplished by the pump 270, which pumps a desired volume of the mixture from the outlet of the grinder 260 to provide a desired concentration of the SWHRRP in the hydrocarbon stream in the main pipeline 250.

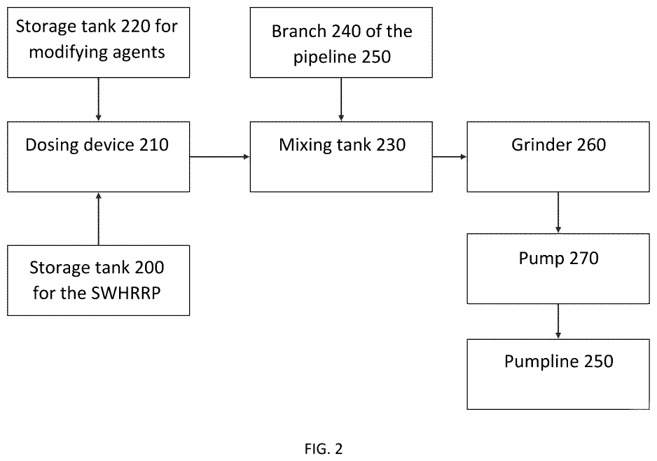

Preferably, at least the device 210, the storage tank 220, and the pump 270 may be controlled by a control unit (not shown in FIG. 2). An operator inserts data concerning the length of the pipeline, the temperature of the hydrocarbons in the pipeline, and the types of the SWHRRP and dissolution modifying agent used into the control unit, which controls the dosing means to provide increased uniformity of action of the SWHRRP in the pipeline.

In one embodiment, the dissolution modifying agents feeder may be configured to dose at least two dissolution modifying agents, one of which accelerates the dissolution of the SWHRRP and the other slows down the dissolution of the SWHRRP. Such a solution makes it possible to ensure a faster action of the SWHRRP at the beginning of the pipeline and to maintain its action at the end of the pipeline. For this purpose, the control unit cyclically feeds one or the other dissolution modifying agent in set amounts.

### EXAMPLES OF CARRYING OUT THE INVENTION

### Embodiment 1

This embodiment and the embodiments disclosed below were tested on a section of the pipeline for hydrocarbon pumping. The parameters of the pumping system and hydrocarbons are as follows:
Pipeline: 49 km.
Working pressure: from 45 to 63 atm.
Hydrocarbon temperature at the beginning of the section: 65° C.
Hydrocarbon temperature at the end of the section: 51° C.
Mass fraction of paraffins: 5.4-6.7%.
Density of raw hydrocarbons: 0.9-0.905 g/cm3.
Dosing concentration of the SWHRRP: 10 g/t.

The pipeline was fed with 10 g/t of the SWHRRP without using the dissolution modifying agent. After setting the mode, the efficiency of the SWHRRP was analyzed. The testing time in the stationary mode was 24 hours.

Following this, rapeseed oil in the amount of 1 wt % was used as the dissolution modifying agent to be fed along with the SWHRRP into the pipeline section. After setting the mode, the efficiency of the SWHRRP was analyzed. The testing time in the stationary mode was 24 hours.

The analyzed efficiency was determined by the increase in pipeline flow capacity at constant pressure (see Table 4).

TABLE 4

| Injectable Substance | Efficiency |
|---|---|
| SWHRRP | 30% |
| SWHRRP + rapeseed oil (1%) | 32% |

### Embodiment 2

Testing was conducted on the pipeline section.
Pipeline: 213 km.
Working pressure: from 50 to 65 atm.
Hydrocarbon temperature at the beginning of the section: 65° C.
Temperature at the end of the section: 30° C.
Mass fraction of paraffins: 5.1-6.2%.
Density of raw hydrocarbons: 0.895-0.905 g/cm3.
Dosing concentration of the SWHRRP: 20 g/t.

The pipeline was fed with 20 g/t of the SWHRRP without using the dissolution modifying agent. After setting the mode, the efficiency of the SWHRRP was analyzed. The testing time in the stationary mode was 24 hours.

Following this, silicone oil in the amount of 1 wt % was used as the dissolution modifying agent to be fed along with the SWHRRP. After setting the mode, the efficiency of the SWHRRP was analyzed. The testing time in the stationary mode was 24 hours. The comparison results are shown in Table 5.

TABLE 5

| Injectable Substance | Efficiency |
|---|---|
| SWHRRP | 36% |
| SWHRRP + silicone oil (1%) | 38% |

### Embodiment 3

Testing was conducted on the pipeline section.
Pipeline: 200 km.
Working pressure: from 50 to 65 atm.
Hydrocarbon temperature at the beginning of the section: 65° C.
Temperature at the end of the section: 30° C.
Mass fraction of paraffins: 5.1-6.2%.
Density of raw hydrocarbons: 0.895-0.905 g/cm3.
Dosing concentration of the SWHRRP: 20 g/t.

The pipeline was fed with 20 g/t of the SWHRRP without using the dissolution modifying agent. After setting the mode, the efficiency of the SWHRRP was analyzed. The testing time in the stationary mode was 24 hours.

Following this, silicone oil in the amount of 1 wt % was used as the dissolution modifying agent for cyclic dosing together with the SWHRRP (feeding period of 1 minute, interval of 1 minute). After setting the mode, the efficiency of the SWHRRP was analyzed. The testing time in the stationary mode was 24 hours. The comparison results are shown in Table 6.

TABLE 6

| Injectable Substance | Efficiency |
|---|---|
| SWHRRP | 36% |
| SWHRRP + cyclic dosing | 39% |

Tables 4-6 show that the feeding of the dissolution modifying agent leads to an increase in the pumping efficiency of hydrocarbons in real pipelines.

The embodiments are not limited to those embodiments described herein; the other embodiments will be obvious to a person skilled in the art due to information set forth in description, and knowledge of the prior art, without limiting the concept and scope of the invention.

Elements mentioned as singular do not exclude a plurality of elements, unless otherwise specified separately.

Although exemplary embodiments have been described and shown in detail in the accompanying drawings, it should be understood that such embodiments are illustrative only and are not intended to limit a more general solution. The present solution should not be limited to any particular arrangements and constructions shown and described, since various alternative modifications can be obvious to those skilled in the pertinent art.

The features mentioned in the various dependent claims, as well as the implementations disclosed in various parts of the description, may be combined to achieve useful effects even if the possibility of such combination is not explicitly disclosed.

Any numerical values set forth in the materials of this description or in the figures are intended to include all values from the lower value to the upper value in increments of one unit element, provided that there is an interval of at least two unit elements between any lower value and any upper value. For example, when it is stated that the magnitude of a component or the value of a process parameter, such as temperature, pressure, or time, has a value from 1 to 90, preferably from 20 to 80, and more preferably from 30 to 70, it is understood that values such as from 15 to 85, from 22 to 68, from 43 to 51, from 30 to 32, and so on, are expressly enumerated in this description of the invention. With respect to values that are less than one, if necessary, a single unit element is considered to have a value of 0.0001, 0.001, 0.01, or 0.1. These are merely examples of what is expressly intended, and all possible combinations of multiple values between the lowest value listed and the highest value shall be deemed to be expressly set forth in this application in a similar manner

1. A method of feeding a substance with properties of reducing hydraulic resistance into a hydrocarbon stream, comprising the steps of:
supplying said substance in a form of an amorphous polymeric mass with at least one dissolution modifying agent to an inlet of a dosing device;
adding a mixture produced at an outlet of the dosing device to a predetermined volume of hydrocarbons using a grinder to produce gel, suspension, or mixture thereof uniformly distributed over the volume of hydrocarbons;
supplying the produced gel, suspension, or mixture thereof to the hydrocarbon stream in a pipeline using a pump;
whereas a dosing of the dissolution modifying agent into the amorphous polymeric mass depends on at least one of factors, comprising: hydrocarbon parameters and a length of a pipeline.

2. The method of claim 1, wherein the dissolution modifying agent is provided as an additive that reduces or increases a dissolution rate of the amorphous polymeric mass in the hydrocarbon stream.

3. The method of claim 2, wherein the dissolution modifying agent is selected from the group consisting of: ethylene glycol, propylene glycol, ethylene glycol methyl ether, methyl alcohol, ethyl alcohol, octanol, 2-ethylhexanol, decanol, dodecanol, texanol, rapeseed oil, canola oil, soybean oil, sunflower oil, cotton seed oil, palm oil, vegetable oil, rapeseed oil fatty acids, canola oil fatty acids, soybean oil fatty acids, sunflower oil fatty acids, cotton seed oil fatty acids, palm oil fatty acids, vegetable oil fatty acids, silicone oil.

4. The method of claim 1, wherein at least two dissolution modifying agents are used to increase an uniformity of the amorphous polymeric mass along the length of the pipeline.

5. The method of claim 1, wherein the dosing device is selected from the group consisting of: a screw feeder, a metering pump, a conveyor belt, or a sectional feeder.

6. The method of claim 1, wherein the grinder is selected from the group consisting of: a disk mill, a colloid mill, a ball mill, an attrition mill, a cam-type grinder, an auger mixer, a roller mixer, a disperser, or a mixer.

7. The method of claim 4, wherein the dissolution modifying agent that increases the dissolution rate and the dissolution modifying agent that decreases the dissolution rate are dosed cyclically.

8. A method of transporting hydrocarbons, comprising the steps of:
supplying a substance with hydraulic resistance reduction properties in a form of an amorphous polymeric mass with a dissolution modifying agent to an inlet of a dosing device;
adding a mixture produced at an outlet of the dosing device to a predetermined volume of hydrocarbons using a grinder to produce gel, suspension, or mixture thereof uniformly distributed over a volume of hydrocarbons;
supplying the produced gel, suspension, or mixture thereof to a hydrocarbon stream in a pipeline using a pump;
transporting the hydrocarbon stream through the pipeline using a second pump,
whereas a dosing of the dissolution modifying agent into the amorphous polymeric mass depends on at least one of factors, comprising: hydrocarbon parameters and a length of a pipeline.
